(19) United States
(12) Patent Application Publication
(10) Pub. No.: US 2026/0269879 A1
(43) Pub. Date: Sep. 10, 2026

(54) METHODS, APPARATUSES AND MEDIA FOR PHASE NOISE RESILIENT HYBRID BEAMFORMING

(71) Applicants: Huawei Technologies Canada Co., Ltd., Ottawa (CA); The University of British Columbia, Vancouver (CA)

(72) Inventors: Faramarz Jabbarvaziri, Vancouver (CA); Peyman Neshaastegaran, Stittsville (CA); Lutz Hans-Joachim Lampe, Vancouver (CA); Ming Jian, Kanata (CA)

(21) Appl. No.: 19/643,624

(22) Filed: Apr. 9, 2026

Related U.S. Application Data
(63) Continuation of application No. PCT/CA2024/050072, filed on Jan. 23, 2024.
(60) Provisional application No. 63/543,964, filed on Oct. 13, 2023.

(51) Int. Cl. H04B 7/0413; H04B 7/06; H04W 72/23

(52) U.S. Cl. CPC H04B 7/0413; H04B 7/0617; H04B 7/0626; H04W 72/23

(57) ABSTRACT

Methods, apparatuses, and storage media are for phase noise resilient hybrid beamforming comprising using a deep neural network (DNN) for pre distortion of a signal for communication including mmWave and MIMO orthogonal frequency division multiplexing (MIMO OFDM) transmission, where symbol indices of each frame of the signal are treated as exogenous variables of the DNN.

### CROSS-REFERENCE TO RELATED APPLICATIONS

This application is a continuation of International Application No. PCT/CA2024/050072, filed on Jan. 23, 2024, which claims priority and benefit of U.S. Provisional Patent Application No. 63/543,964 filed on Oct. 13, 2023, the entire contents of which are hereby incorporated by reference in their entirety.

### FIELD OF THE DISCLOSURE

The present disclosure relates generally to hybrid beamforming, and in particular to methods and apparatuses of hybrid beamforming using deep neural networks for pre-distortion of a signal.

### BACKGROUND

Fifth-generation mobile networks (5G) generally support a wide variety of applications that require communication at higher data rates, such as in the range of multiple gigabits per second for applications such as augmented reality and virtual reality. To meet these requirements, the 5G ecosystem may use high-frequency bands such as millimeter-wave (mmWave) and multiple-input multiple-output (MIMO), which have become important components of deployed 5G systems. State-of-the-art mmWave transceiver architectures may leverage hybrid beamforming (HBF), which is a combination of digital and analog beamforming, for providing antenna patterns comprising high directivity gain to compensate for large path losses in mmWave systems while minimizing manufacturing costs and power consumption. There remains a need for improved methods of HBF.

### SUMMARY

Some example embodiments disclosed herein relate to methods and apparatuses for phase noise resilient hybrid beamforming comprising using a deep neural network (DNN) for pre distortion of a signal for communication including mmWave and MIMO orthogonal frequency division multiplexing (MIMO OFDM) transmission, where symbol indices of each frame of the signal are treated as exogenous variables of the DNN.

In a broad aspect of the present disclosure, a method comprises: determining one or more beam forming matrices using a DNN for pre distortion of a signal, wherein symbol indices of each frame of the signal are exogenous variables of the DNN; and transmitting the one or more beam forming matrices.

In a broad aspect of the present disclosure, a method comprises: determining one or more beam forming matrices using a DNN for pre distortion of a signal for MIMO OFDM transmission, wherein symbol indices of each frame of the signal are exogenous variables of the DNN; and transmitting the one or more beam forming matrices.

In some implementations of the present disclosure, beam forming matrices are for multiple input, multiple output orthogonal frequency division multiplexing (MIMO OFDM) transmission.

In some implementations, the one or more beam forming matrices are transmitted from a base station.

In some implementations of the present disclosure, the one or more beam forming matrices are transmitted from a physical downlink control channel of the base station.

In some implementations of the present disclosure, the DNN comprises a residual network (ResNet) architecture, wherein the symbol indices as exogenous variables are concatenated with channel state information.

In some implementations of the present disclosure, ResNet architecture comprises two or more sub ResNet architectures interconnected in a tree structure.

In some implementations of the present disclosure, the method further comprises training the DNN using simulated or estimated phase noise samples as input to a cost function of the DNN.

In some implementations of the present disclosure, the method further comprises training the DNN using simulated phase noise samples as input to a cost function of the DNN.

In some implementations, the simulated phase noise samples are produced using Wiener distribution modelling.

In some implementations, the simulated phase noise samples are produced using Ornstein Uhlenbeck distribution modelling.

In some implementations, the method further comprises re-training the DNN contemporaneously during operation using a snapshot of data of the signal.

In a broad aspect of the present disclosure, an apparatus comprises one or more processors for executing instructions stored in a memory coupled to the processors for performing the method. The method comprises: determining one or more beam forming matrices using a DNN for pre distortion of a signal, wherein symbol indices of each frame of the signal are exogenous variables of the DNN; and transmitting the one or more beam forming matrices.

In some implementations, the apparatus further comprises the memory.

In some implementations, the beam forming matrices are for MIMO OFDM transmission.

In some implementations, the one or more beam forming matrices are transmitted from a base station.

In some implementations, the one or more beam forming matrices are transmitted from a physical downlink control channel of the base station.

In some implementations, the DNN comprises a ResNet architecture, wherein the symbol indices as exogenous variables are concatenated with channel state information.

In some implementations, the ResNet architecture comprises two or more sub ResNet architectures interconnected in a tree structure.

In some implementations, the one or more processors are further for training the DNN using simulated phase noise samples as input to a cost function of the DNN.

In some implementations, the simulated phase noise samples are produced using Wiener distribution modelling.

In some implementations, the simulated phase noise samples are produced using Ornstein Uhlenbeck distribution modelling.

In some implementations, the one or more processors are further for training the DNN using estimated phase noise samples as input to a cost function of the DNN.

In some implementations, the one or more processors are further for re-training the DNN contemporaneously during operation using a snapshot of data of the signal.

In a broad aspect of the present disclosure, one or more non-transitory computer-readable storage media comprises computer-executable instructions for performing the method.

In details, the computer-executable instructions are for determining one or more beam forming matrices using a DNN for pre distortion of a signal, wherein symbol indices of each frame of the signal are exogenous variables of the DNN; and transmitting the one or more beam forming matrices.

In some implementations, the beam forming matrices are for MIMO OFDM transmission.

In some implementations, the one or more beam forming matrices are transmitted from a base station.

In some implementations, the one or more beam forming matrices are transmitted from a physical downlink control channel of the base station.

In some implementations, the DNN comprises a ResNet architecture, wherein the symbol indices as exogenous variables are concatenated with channel state information.

In some implementations, the ResNet architecture comprises two or more sub ResNet architectures interconnected in a tree structure.

In some implementations, the executable instructions are further for training the DNN using simulated phase noise samples as input to a cost function of the DNN.

In some implementations, the simulated phase noise samples are produced using Wiener distribution modelling.

In some implementations, the simulated phase noise samples are produced using Ornstein Uhlenbeck distribution modelling.

In some aspects of the present disclosure, there is provided a computer program comprising instructions. The instructions, when executed by a processor, may cause the processor to implement a method of the present disclosure.

In some implementations, the executable instructions are further for training the DNN using estimated phase noise samples as input to a cost function of the DNN.

In some implementations, the executable instructions are further for re-training the DNN contemporaneously during operation using a snapshot of data of the signal.

### BRIEF DESCRIPTION OF THE DRAWINGS

For a more complete understanding of the disclosure, reference is made to the following description and accompanying drawings, in which:

FIG. 1 is a schematic diagram showing a portion of a system for hybrid beamforming;

FIG. 2 is a schematic diagram showing a portion of a system for multi user multiple-input multiple-output orthogonal frequency division multiplexing hybrid beamforming according to some examples of the present disclosure;

FIG. 3A is a schematic diagram of a method for hybrid beamforming;

FIG. 3B is a schematic diagram of a method for hybrid beamforming comprising a phase noise affected channel state information acquisition module and a machine learning based hybrid beamforming module according to some examples of the present disclosure;

FIG. 4 is a schematic diagram of a training phase of method according to some examples of the present disclosure using random phase noise;

FIG. 5 is a schematic diagram of a deployment phase of the method of FIG. 4;

FIG. 6 is a schematic diagram of an adaptive squeeze and excitation residual neural network according to some examples of the present disclosure;

FIG. 7 is a schematic diagram of an embodiment of the network of FIG. 6;

FIG. 8 is a schematic diagram of a loss function of a method according to some examples of the present disclosure;

FIG. 9 is a constellation diagram comparing received constellations and AIR of an example of the method of the present disclosure and large scale antenna array hybrid beamforming;

FIG. 10 is a schematic diagram of a training phase of a method according to some examples of the present disclosure using estimated phase noise; and

FIG. 11 is a block diagram of a method according to some embodiments of this disclosure.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

The term “a” or “an” refers to one or more of that entity; for example, “a terminal” refers to one or more terminals or at least one terminal. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., systems), unless clearly intended, does not mean that the systems or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

As those skilled in the art will appreciate, the embodiments disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as random access memory, read only memory, electrically erasable programmable read-only memory, solid-state memory devices, hard disks, compact discs, digital video discs, flash memory devices, and/or the like. The module may read the computer-executable code from the storage devices and execute the computer-executable code to perform hybrid beamforming processes.

Multiple-input, multiple-output orthogonal frequency division multiplexing (MIMO OFDM) hybrid beamforming may be used for technologies relating to MIMO OFDM multiplexing systems for applications in high-speed wireless communications. MIMO OFDM hybrid beamforming may comprise a combination of analog beamforming and digital beamforming techniques for efficiently providing created beams or focused signals toward receivers.

Phase noise may refer to random fluctuations in the phase of signals, which may result from a number of factors such as timing jitter and phase instability. In beam forming systems, phase noise may result in distortions and may degrade performance of the systems.

Achievable information rate is a measure of a maximum rate of reliable communication that may be provided over a particular communication channel with specified constraints, such as power limits and noise levels. Achievable information rate may be measured in bits per second.

Radio frequency chains may refer to the number of independent wireless signal paths that may be used for transmitting and receiving wireless signals. Increasing the number of radio frequency chains used may improve signal reception and transmission quality.

A local oscillator (LO) is an electronic device that generates a signal comprising a constant waveform, and is commonly used for applications for conversion between different frequencies. In some embodiments of the present disclosure, a local oscillator may be connected to each radio frequency chain in both base stations and in user equipment. Local oscillators may be a source of phase noise in communications systems.

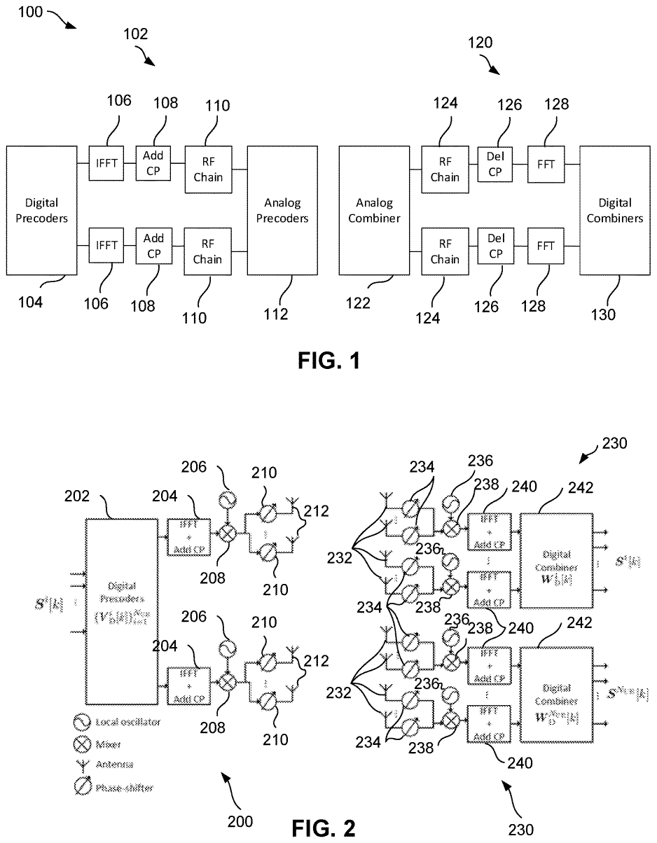

Referring to FIG. 1, a portion of a system for hybrid beamforming 100 comprises a base station side module 102 and a user side module 120. The base station side module 102 comprises one or more digital precoders 104, one or more inverse fast Fourier transform (FFT) modules 106, one or more cyclic prefix (CP) adders 108, one or more radio frequency chains 110, and one or more analog precoders 112. A signal in the base station side module 102 goes through digital precoding at the one or more digital precoders 104, processing by the one or more inverse FFT modules 106, have cyclic prefixes added by the one or more cyclic prefix adders 108, frequency up-converted, provided to the one or more radio frequency chains 110, and converted to signal suitable for analog transmission by the one or more analog precoders 112, the one or more analog precoders 112 each comprising a network of adjustable phase-shifters and signal adders to provide signals to a transmission antenna array.

The user side module 120 comprises one or more analog combiners 122, one or more radio frequency chains 124, one or more cyclic prefix deleters 126, one or more FFT modules 128, and one or more digital combiner modules 130. A signal originating from the base station module 102 is received and then transformed by the analog combiners 122, the analog combiners 122 comprise a similar structure to the analog precoders 112 of the base station side module 102. The signal is frequency down-converted by the one or more radio frequency chains 124, have cyclic prefixes removed by the one or more CP deleters 126, processed by the one or more FFT modules 128, transformed by the one or more digital combiner modules 130. Channel estimation and equalization may then be performed using a demodulation reference signal.

In some embodiments of the present disclosure, a method may comprise a descent-based optimization method to solve disjoint hybrid beamforming optimization tasks until convergence is reached by performing the method iteratively. Once the optimization is complete, precoding and combining matrices may be distributed among users using a control channel in downlink. The downlink may originate from a base station and may be from a physical downlink control channel of a base station. The precoding and combining matrices may jointly provide antenna patterns having high directivity gain to compensate for large path losses in millimeter wave (mmWave) applications and may significantly improve information transmission rates.

Where V_{RF} represents the analog precoder, W_{RF} represents the analog combiner, V_{D} represents the digital precoder, and W_{D} represents the digital combiner, optimization may be represented by the following expression:

$$maximize \frac{1}{K} {\sum }_{k = 1}^{K} R [ k ]$$

$$subject to Tr ( {V}_{RF} {V}_{D} {V}_{D}^{H} {V}_{RF}^{H} ) \leq P , \vert {V}_{RF} ( i , j ) \vert = 1 , \vert {W}_{RF} ( i , j ) \vert = 1$$

$$where ,$$

$$R [ k ] = {log}_{2} \vert I + \frac{1}{{σ}^{2}} C [ k ] H [ k ] {V}_{t} [ k ] {V}_{t}^{H} [ k ] {H}^{H} [ k ] \vert ,$$

$$C [ k ] = {W}_{t} [ k ] {( {W}_{t}^{H} [ k ] {W}_{t} [ k ] )}^{- 1} {W}_{t}^{H} [ k ] ,$$

$${V}_{t} [ k ] = {V}_{RF} {V}_{D} , and$$

$${W}_{t} [ k ] = {W}_{RF} {W}_{D} .$$

The above method of optimization is non-convex and intractable, and requires constant solving during communication for online optimizing resulting in a method comprising a very large computational complexity. Moreover, phase noise from the local oscillator represents a significant hardware-related disadvantage in mmWave MIMO systems, mainly due to its substantial impact on signal constellation rotation, also known as common phase error (CPE), increased inter-carrier interference (ICI), and the spatial selectivity of beamforming. Although extensive efforts have been expended to address the influence of phase noise on ICI and CPE, methods of mitigation thereof, a significant deficiency remains in addressing phase-noise-induced beamforming mismatch and its resulting effects. Beamforming array factor mismatch, side-lobe level increase, and gain loss may not be corrected during data detection, mainly due to beamforming distortions affecting the spatial filtering process, resulting in a mismatch between the actual and intended beam patterns, ultimately influencing the received signal's directionality and spatial selectivity.

Some embodiments of the present disclosure provide methods and apparatus for a computationally-tractable machine-learning-based HBF optimization while addressing issues resulting from phase noise. Phase noise may result in impairments such as beamforming array factor mismatch, side-lobe level increase, and gain loss. Such impairments may not be corrected during data detection, mainly due to beamforming distortions affecting the spatial filtering process, resulting in a mismatch between actual and intended beam patterns, which ultimately influences the received signal's directionality and spatial selectivity.

Advances in machine learning may offer a solid foundation for providing solutions to address issues relating to phase-noise-induced beamforming mismatch. The use of machine learning in applications relating to communication systems has increased resulting in the development of many deep-learning-based beamforming optimization methods. Deep-learning-based beamforming optimization methods may replace conventional gradient-based online optimization methods with a deep neural network (DNN) that directly maps channel state information (CSI) to beamforming matrices, optimizing such mapping during the training phase for enhanced performance.

In some embodiments of the present disclosure, a method for determining one or more beamforming matrices using a DNN for pre-distortion of a signal comprises an attention mechanism specifically configured to enhance robustness against time-varying beamforming mismatch. To effectively mitigate inter-carrier interference (ICI) resulting from phase noise, a phase-noise-affected achievable information rate (AIR) may be used as the loss function for a machine learning algorithm. To provide robustness against time-varying effects of phase noise, a symbol index is processed by the machine learning algorithm as an exogenous variable.

The data-driven nature of the disclosed embodiments of the method enables operation without relying on a phase noise model, allowing the utilization of real-world phase-noise measurements for training. This aspect of the embodiments of the method of the present disclosure makes the method suitable for a wide range of practical scenarios. Furthermore, the method comprises tractable computational complexity during an inference phase, the computational complexity increasing linearly with the number of users and subcarriers, and quadratically with the number of antennas. Respecting parameters of some embodiments of the machine learning method disclosed herein, the method scales sub-linearly with the number of antennas and remains constant with respect to the number of subcarriers and users.

Some of embodiments of the presently disclosed method may be used in a multi-user MIMO OFDM application. Referring to FIG. 2, a system for a multi-user MIMO OFDM application comprises a base station 200 and one or more user terminal devices 230, with two shown in FIG. 2. Each base station 200 and the user terminal devices 230 comprise an antenna array with a hybrid digital/analog structure, radio frequency chains for up and down-converting a signal to and from high frequency, the radio frequency chains comprise independent local oscillators, the local oscillators generating a level of phase noise depending on the quality of the material, manufacturing, and temperature. The base station 200 comprises one or more digital precoders 202, one or more modules for performing inverse FFTs and adding cyclic prefixes 204, one or more oscillators 206, one or more mixers 208 for combining a signal from a local oscillator 206 (and the signal from a module for performing inverse FFTs and adding cyclic prefixes 204), one or more phase shifters 210 and one or more antennae 212. Each of the one or more user terminal devices 230 comprises one or more antennae 232, one or more phase shifters 234, one or more local oscillators 236, one or more mixers 238 for combining a signal from a local oscillator 236 (and a signal from a phase shifter 234), one or more modules for performing inverse FFTs and adding cyclic prefixes 240, and one or more digital combiners 242. Referring to FIG. 2, local oscillators 206 and 236 may be a source of phase noise, which may affect performance of hybrid beamforming.

Some embodiments of the present disclosure may be implemented in software, firmware, hardware, or any combination thereof. The method may be performed on a base station for optimizing hybrid beamforming matrices. The disclosed method generates a set of precoding and combining matrices for each symbol transmission within a frame.

To communicate the precoding and combining matrices to user terminal devices, additional downlink overhead is introduced. The precoding and combining matrices may be transmitted using a physical downlink control channel. An increase in downlink overhead may be a characteristic of the use of some embodiments of the presently disclosed method. The method may significantly reduce the need to frequently refresh a need to refresh channel estimation. This reduction may be another distinct characteristic of use of the method of the present disclosure.

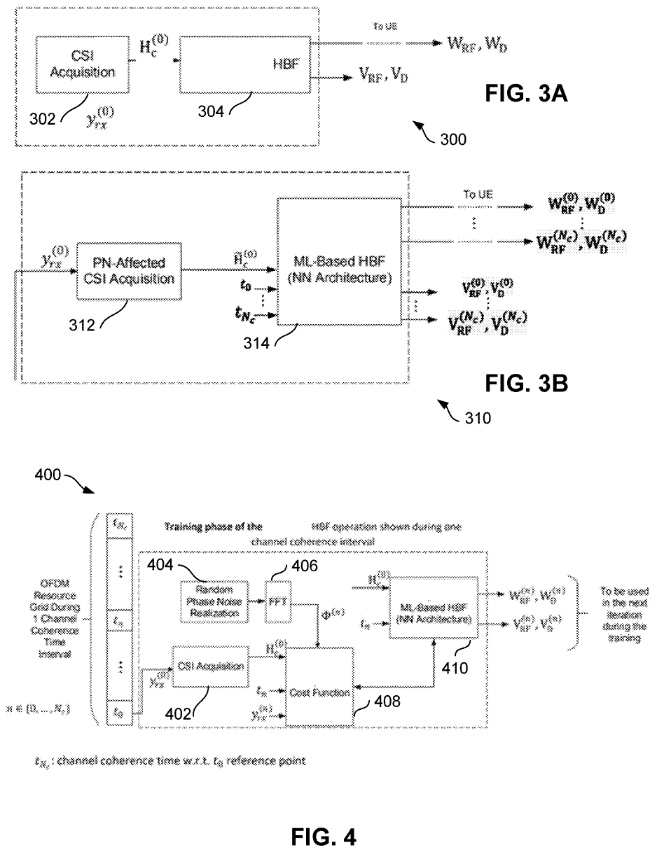

Finally, using OFDM symbol index (nₛ) as an input to a DNN for providing generated beamforming matrices for each OFDM symbol is another indicator of the use of some embodiments of the present disclosure. V_{RF} may represent an analog precoder, W_{RF} may represent an analog combiner, V_{D} may represent a digital precoder, and W_{D} may represent a digital combiner, Referring to FIG. 3A, a set of V_{RF}, W_{RF}, V_{D}, and W_{D} is provided to user equipment. The method of FIG. 3A 300 comprises a channel state information acquisition module 302 and a hybrid beamforming module 304. Referring to FIG. 3B, in some embodiments of the present disclosure, t₀, . . . , t_{Nc} are OFDM symbol indices in a frame and nₛ∈{t₀, . . . , t_{Nc}}, and a set of V_{RF}, W_{RF}, V_{D}, and W_{D} is provided to user equipment for each symbol transmission within a frame at each index t_{Nc}. The method of FIG. 3B 310 comprises a phase noise affected channel state information acquisition module 312 and a machine learning based hybrid beamforming module 314.

FIG. 4 illustrates a training phase of some methods of the present disclosure 400, the method comprising a channel state information acquisition module 402, a random phase noise realization module 404, a FFT module 406, a cost function 408, and a machine learning based hybrid beamforming module 410. Note that in the training loop, simulated phase noise samples are provided to the cost function module 408. The simulated phase noise samples may originate from a Wiener distribution modeling a free-running oscillator but other distributions may also be used, such as Ornstein Uhlenbeck for phase-lock-loop synthesizers.

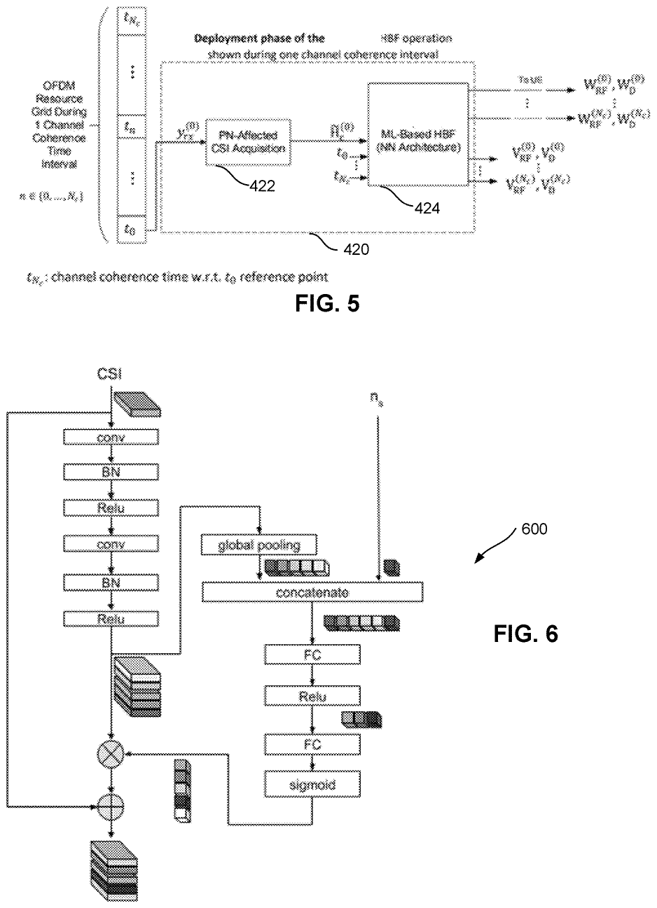

FIG. 5 illustrates an inference or deployment phase of some methods of the present disclosure 420, the method comprising a phase noise affected channel state acquisition module 422 and a machine learning based hybrid beamforming module 424.

The flow of data during both the training phase of the method 400 and the inference phase of the method 420 is unique, wherein an important aspect are components relating to machine learning based hybrid beamforming, which may comprise a deep neural network further comprising several smaller modules, which may be referred to as adaptive squeeze and excitation residual neural network (AdaSE-ResNet).

In some embodiments of the present disclosure, an AdaSE-ResNet architecture is a modified version of a specific type of residual network (ResNet), namely squeeze-and-excitation ResNet. Referring to FIG. 6, components of an AdaSE-ResNet module 600 are illustrated. The module 600 integrates an attention module with a convolution neural network. An important distinction between an AdaSE-ResNet module 600 and a squeeze-and-excitation ResNet module is the use of exogenous meta-information. By concatenating OFDM symbol indexes with output of global pooling (from a squeeze-and-excitation ResNet module) and providing them to a fully connected network or excitation module, attentional weights of an AdaSE-ResNet module may effectively utilize auxiliary information. This enables the module to attend to the channel state information context and nₛ, allowing the module to learn a unique feature-map re-calibration strategy for each nₛ that depends on the channel state information context. As a result, the machine learning module may adaptively pre-distort a beamforming solution, to address increasing phase-noise-induced beamforming mismatch. Beamforming pre-distortion is for adapting beamforming matrices for each point in time to optimize the beamforming performance in a time dimension. The main flow of information originating from a channel state information matrix generates optimal beamforming based on a channel state information instance, while an auxiliary path allows the module to adapt to a changing nₛ over time.

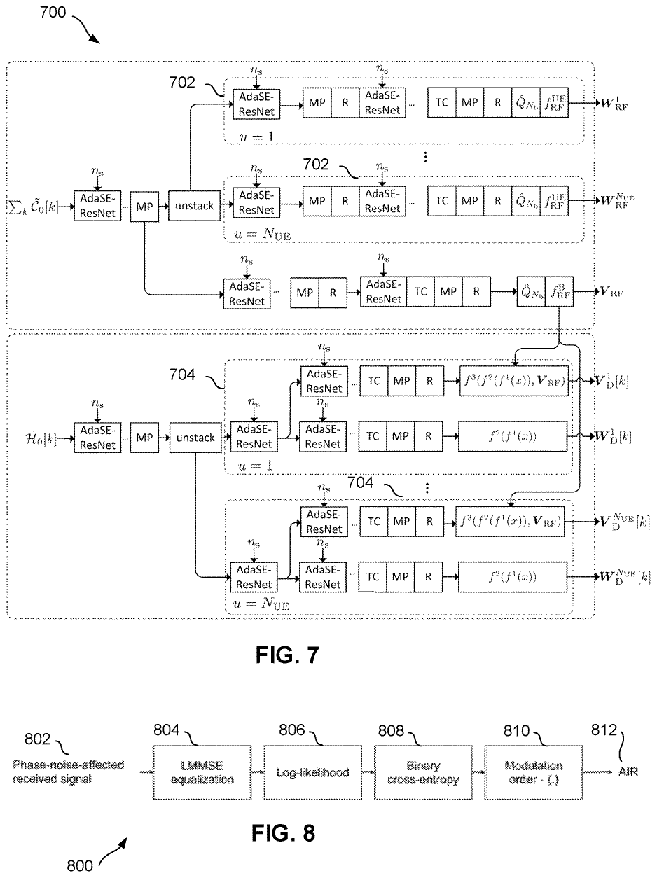

In some embodiments of the present disclosure, an architecture comprises connecting a plurality of AdaSE-ResNets in a tree-like structure to enhance learning capacity. Referring to FIG. 7, in some embodiments of the present disclosure, an architecture 700 comprises a plurality of sub-network modules comprising multiple cascaded AdaSE-ResNets, transposed convolution (TC) layers, (R) reshaper layers, and maxpooling (MP) layers, as well as activation functions [symbol] performing tanh-approximated quantization for the analog phase shifters, functions

$$\{ {f}_{1} , {f}_{2} , {f}_{3} , {f}_{RF}^{UE} , {f}_{RF}^{B} \}$$

performing transformations for generating the right output type and shape and power normalization configured for each user in a system. Each sub-network module may comprise an upper segment portion 702 and a lower network portion 704, wherein the upper segment portion 702 is for processing aggregated channel covariance matrix across subcarriers, while the lower segment portion 704 handles individual per-subcarrier channels. The learnable parameters of the sub-network modules may be bound to prevent an overall neural network's parameter count from increasing with the number of users. As long as users of a system share the same antenna array structure and each user-specific sub-network possesses adequate learning capacity, the aforementioned parameter binding process may not adversely impact performance of the system. Note that each sub-network module comprises a user-specific channel input, thereby generating a user-specific output.

FIG. 8 illustrates a loss function 800 of some methods of the present disclosure. A phase-noise-affected received signal 802 is provided to a linear minimum mean square error equalization module 804 and is subsequently processed by a log-likelihood module 806, a binary cross-entropy module 808, and a modulation order module 81o to provide a phase-noise-affected achievable information rate (AIR) 812. A negative of AIR is used as the loss function during training to capture inter-carrier interference caused by phase noise.

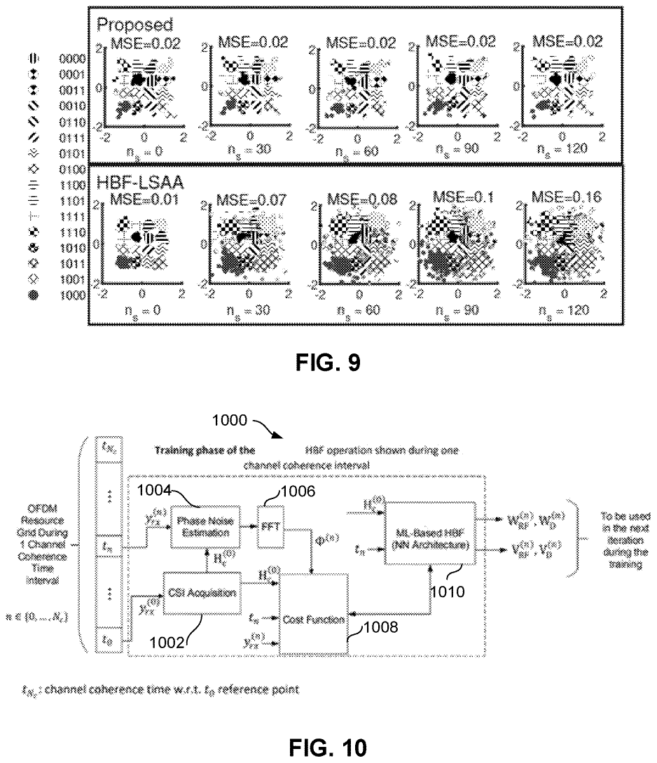

FIG. 9 represents an example comparison of received constellations and AIR of an embodiment of the method of the present disclosure and large scale antenna array hybrid beamforming (HBF-LSAA), wherein the method of the present disclosure demonstrates a robust constellation that is more resilient against phase noise effects.

FIG. 10 illustrates a training phase of some methods of the present disclosure 1000, the method comprising a channel state information acquisition module 1002, an estimated phase noise sample module 1004, a FFT module 1006, a cost function 1008, and a machine learning based hybrid beamforming module 1010. Note that in the training loop of this method 1000, estimated phase noise samples are used instead of simulated phase noise.

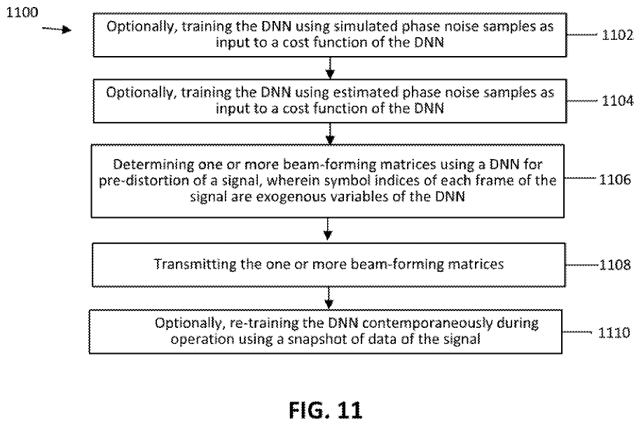

FIG. 11 is a flowchart showing the steps of a method 1100 according to some embodiments of the present disclosure. The method 1100 begins with, optionally, training the DNN using simulated phase noise samples as input to a cost function of the DNN (at step 1102). At step 1104, the method comprises, optionally, training the DNN using simulated phase noise samples as input to a cost function of the DNN. At step 1106, the method comprises determining one or more beam-forming matrices using a DNN for pre-distortion of a signal, wherein symbol indices of each frame of the signal are exogenous variables of the DNN. At step 1108, the method comprises transmitting the one or more beam-forming matrices. At step 1110, the method comprises, optionally, re-training the DNN contemporaneously during operation using a snapshot of data of the signal.

In some embodiments of the present disclosure, the DNN may be contemporaneously re-trained during operation using a snapshot of data of a signal to further enhance performance.

Although embodiments have been described above with reference to the accompanying drawings, those of skill in the art will appreciate that variations and modifications may be made without departing from the scope thereof as defined by the appended claims.

What is claimed is:

1. A method comprising:
determining, using a deep neural network (DNN), one or more beam-forming matrices for pre-distortion of a signal, wherein symbol indices of each frame of the signal are exogenous variables of the DNN; and
transmitting the one or more beam-forming matrices.

2. The method of claim 1, wherein the one or more beam-forming matrices are for multiple-input, multiple-output (MIMO) orthogonal frequency-division multiplexing (OFDM) transmission.

3. The method of claim 1, wherein the one or more beam-forming matrices are transmitted from a base station.

4. The method of claim 3, wherein the one or more beam-forming matrices are transmitted from a physical downlink control channel (PDCCH) of the base station.

5. The method of claim 1, wherein the DNN comprises a residual network (ResNet) architecture, and wherein the symbol indices as the exogenous variables are concatenated with channel state information (CSI).

6. The method of claim 5, wherein the ResNet architecture comprises two or more sub-ResNet architectures interconnected in a tree structure.

7. The method of claim 1, further comprising:
training the DNN using simulated phase noise samples as input to a cost function of the DNN.

8. The method of claim 1, further comprising:
training the DNN using estimated phase noise samples as input to a cost function of the DNN.

9. The method of claim 1, further comprising:
re-training the DNN contemporaneously during operation using a snapshot of data of the signal.

10. An apparatus comprising:
a memory; and
one or more processors for executing instructions stored in the memory to cause the apparatus to perform:
determining, using a deep neural network (DNN), one or more beam-forming matrices for pre-distortion of a signal, wherein symbol indices of each frame of the signal are exogenous variables of the DNN; and
transmitting the one or more beam-forming matrices.

11. The apparatus of claim 10, wherein the one or more beam-forming matrices are for multiple-input, multiple-output (MIMO) orthogonal frequency-division multiplexing (OFDM) transmission.

12. The apparatus of claim 10, wherein the one or more beam-forming matrices are transmitted from a base station.

13. The apparatus of claim 12, wherein the one or more beam-forming matrices are transmitted from a physical downlink control channel (PDCCH) of the base station.

14. The apparatus of claim 10, wherein the DNN comprises a residual network (ResNet) architecture, and wherein the symbol indices as the exogenous variables are concatenated with channel state information (CSI).

15. The apparatus of claim 14, wherein the ResNet architecture comprises two or more sub-ResNet architectures interconnected in a tree structure.

16. The apparatus of claim 10, wherein the one or more processors execute the instructions to further cause the apparatus to perform:
training the DNN using simulated phase noise samples as input to a cost function of the DNN.

17. The apparatus of claim 10, wherein the one or more processors execute the instructions to further cause the apparatus to perform:
training the DNN using estimated phase noise samples as input to a cost function of the DNN.

18. The apparatus of claim 10, wherein the one or more processors execute the instructions to further cause the apparatus to perform:
re-training the DNN contemporaneously during operation using a snapshot of data of the signal.

19. One or more non-transitory computer-readable storage media comprising computer-executable instructions that, when executed by an apparatus, cause the apparatus to perform operations, the operations comprising:
determining, using a deep neural network (DNN), one or more beam-forming matrices for pre-distortion of a signal, wherein symbol indices of each frame of the signal are exogenous variables of the DNN; and
transmitting the one or more beam-forming matrices.

20. The one or more non-transitory computer-readable storage media of claim 19, wherein the one or more beam-forming matrices are for multiple-input, multiple-output (MIMO) orthogonal frequency-division multiplexing (OFDM) transmission.
